(19) United States
(12) Patent Application Publication
(10) Pub. No.: US 2007/0047639 A1
(43) Pub. Date: Mar. 1, 2007

(54) Rate-distortion video data partitioning using convex hull search

(75) Inventor: Jong C. Ye, Yuseong-Gu (KR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/573,086

(22) PCT Filed: Sep. 21, 2004
(86) PCT No.: PCT/IB04/51811

§ 371 Date: Mar. 23, 2006

Related U.S. Application Data
(60) Provisional application No. 60/505,221, filed on Sep. 23, 2003.

(51) Int. Cl. H04B 1/66; H04N 7/12

(52) U.S. Cl. 375/240.1; 375/240.26

(57) ABSTRACT

Method for partitioning video data into a base layer and at least one enhancement layer entailing receiving video data, determining DCT coefficients for a plurality of blocks of a video frame to form the base layer and the at least one enhancement layer and for each block, quantizing the DCT coefficients, converting the quantized DCT coefficients of the base layer into a set of (run, length) pairs, and determining which pairs lie on a convex hull. Thereafter rate-distortion optimal partitioning points are determined from only those pairs which lie on the convex hull in a causally optimal way. The (run, length) pairs before and inclusive of the partitioning point are encoded in the base layer while the other (run, length) pairs are encoded in the enhancement layer(s). A video encoder (22) and decoder (28) applying the method are also disclosed.

The present invention relates generally to scalable video coding systems and more particularly to rate-distortion optimized data partitioning (RDDP) of discrete cosine transform (DCT) coefficients for video transmission.

Video is a sequence of pictures. Each picture is formed by an array of pixels. The size of uncompressed video is huge and therefore video compression is often used to reduce the size and improve the data transmission rate. Various video coding methods (e.g., MPEG 1, MPEG 2, and MPEG 4) have been established to provide an international standard for the coded representation of moving pictures and associated audio on digital storage media.

Such video coding methods format and compress the raw video data for reduced rate transmission. For example, the format of the MPEG 2 standard consists of 4 layers: Group of Pictures, Pictures, Slice, Macroblock. A video sequence begins with a sequence header that includes one or more groups of pictures (GOP), and ends with an end-of-sequence code. The Group of Pictures (GOP) includes a header and a series of one of more pictures intended to allow random access into the video sequence. The MPEG 2 standard defines three types of pictures: Intra Pictures (I-Pictures) Predicted Pictures (P-Pictures); and Bidirectional Pictures (B-Pictures) which are combined to form a group of pictures.

The pictures are the primary coding unit of a video sequence. A picture consists of three rectangular matrices representing luminance (Y) and two chrominance (Cb and Cr) values. The Y matrix has an even number of rows and columns. The Cb and Cr matrices are one-half the size of the Y matrix in each direction (horizontal and vertical). The slices are one or more “contiguous” macroblocks. The order of the macroblocks within a slice is from left-to-right and top-to-bottom.

The macroblocks are the basic coding unit in the MPEG algorithm. The macroblock is a 16×16 pixel segment in a frame. Since each chrominance component has one-half the vertical and horizontal resolution of the luminance component, a macroblock consists of four Y, one Cr, and one Cb block. The block is the smallest coding unit in the MPEG algorithm. It consists of 8×8 pixels and can be one of three types: luminance (Y), red chrominance (Cr), or blue chrominance (Cb). The block is the basic unit in intra frame coding.

The MPEG transform coding algorithm includes the following coding steps: Discrete cosine transform (DCT), Quantization and Run-length encoding.

An important technique in video coding is scalability. In this regard, a scalable video codec is defined as a codec that is capable of producing a bitstream that can be divided into embedded subsets. These subsets can be independently decoded to provide video sequences of increasing quality. Thus, a single compression operation can produce bitstreams with different rates and reconstructed quality. A small subset of the original bitstream can be initially transmitted to provide a base layer quality with extra layers subsequently transmitted as enhancement layers. Scalability is supported by most of the video compression standards such as MPEG-2, MPEG-4 and H.263.

An important application of scalability is in error resilient video transmission. Scalability can be used to apply stronger error protection to the base layer than to the enhancement layer(s) (i.e., unequal error protection). Thus, the base layer will be successfully decoded with high probability even during adverse transmission channel conditions.

Data Partitioning (DP) is used in connection with the encoder to facilitate scalability. As such, a merging technique is used in connection with the decoder to merge the data to form the correct video images.

With respect to data partitioning, for example in MPEG 2, the slice layer indicates the maximum number of block transform coefficients contained in the particular bitstream (known as the priority break point). Data partitioning is a frequency domain method that breaks the block of 64 quantized transform coefficients into two bitstreams. The first, higher priority bitstream (e.g., base layer) contains the more critical lower frequency coefficients and side information (such as DC values, motion vectors). The second, lower priority bitstream (e.g., enhancement layers) carries higher frequency AC data

One technique for implementing data partitioning outside an encoder entails providing at the transmitter, a demultiplexer which receives from the variable length decoder (VLD) the number of bits used for each variable length code and separates the bitstream based on the priority break point (PBP) value. Note that the PBP's can be changed at each slice based on the rate partitioning logic used. In conventional data-partitioning (DP) video coders (e.g., MPEG), a single layer bit stream is partitioned into two or more bit streams in the DCT domain. During transmission, one or more bit streams are sent to achieve bit rate scalability. Unequal error protection can be applied to base layer and enhancement layer data to improve the resistance to channel degradation.

As to merging of the partitioned data outside the decoder, two VLD's may be used to process the base layer and enhancement layer streams and then output a nonlayered bitstream. The PBP value defines how an encoded bitstream is partitioned. Before decoding, depending on resource allocation and/or receiver capacity, the received bit-streams or a subset thereof are merged into one single bit-stream and decoded.

The conventional DP structure has many advantages in the home network environment. More specifically, at its full quality, the rate-distortion performance of the DP is as good as its single layer counterpart while rate scalability is also allowed. The rate-distortion (R-D) performance is concerned with finding an optimal combination of rate and distortion. This optimal combination, which could also be seen as the optimal combination of cost and quality, is not unique. R-D schemes attempt to represent a piece of information with the fewest bits possible and at the same time in a way that will lead to the best reproduction quality.

It is also noted that in the conventional DP structure, the additional decoding complexity overhead is very minimal at its full quality while the DP provides wider range of decoder complexity scalability. This is because variable length decoding (VLD) of DCT run-length pairs, which is the most computational extensive part, now becomes scalable.

In the conventional DP structure, the DCT priority break point (PBP) value needs to be transmitted explicitly as side information. To minimize overhead, the PBP value is usually fixed for all the DCT blocks within each slice or video packet. While the conventional DP is simple and has many advantages, there is little room for base layer optimization because only one PBP value is used for all blocks within each slice or video packet.

While the conventional DP method is simple and has some advantages, it is not capable of adapting base layer optimization because only one PBP value is used for all blocks within each slice or video packet.

Accordingly, there exists a need for video coding techniques that overcome the limitations of the conventional data partitioning scheme and provide improved base layer optimization.

In the inventor's related disclosure entitled System and Method of Rate-Distortion Optimized Data Partition for Video Coding Using a Parametric Rate-Distortion Model assigned U.S. Ser. No. 60/463,747 filed Apr. 18, 2003; refiled Jul. 29, 2003 and assigned US Ser. No. 60/490,835 (corresponding to Applicant's Reference No. 703553), incorporated by reference herein in its entirety, a rate-distortion optimized data partitioning (RDDP) is described which provides a breakthrough for data partitioning by allowing the PBP value to adapt each at DCT block level with minimal overhead (≈20 bits for each slice or video packet) by employing context-based backward adaptation. Such a block-by-block adaptation is always performed in a rate-distortion optimization scheme which guarantees that the RDDP achieves a nearly optimal video quality under certain convexity conditions on the rate-distortion (RD) planes.

The RDDP is based on a Lagrangian optimization algorithm. A primary advantage of the Lagrangian approach for rate-distortion optimization is its independent property for each signal element. More specifically, the theoretical performance limit of the data partitioning can be achieved by minimizing the following cost function:

$${min}_{h} \{ {D}_{i}^{( h )} + λ {R}_{i}^{( h )} \} , i = 1 , … , Q \qquad ( 1 )$$

where Dᵢ^{(h)} and Rᵢ^{(h)} denote distortion and rate for the base layer of the i-th DCT block when the break point is h and Q denotes the number of total DCT blocks in each frame. The solution of the Lagrangian optimization problem (1) lies in the convex hull of the R-D points.

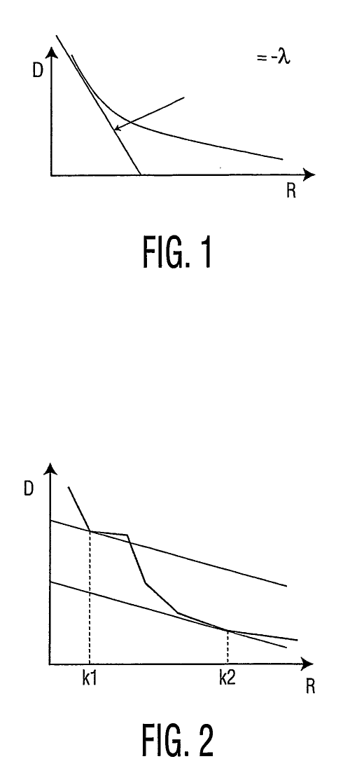

Considering a typical convex R-D curve as shown in FIG. 1, the minimum Lagrangian function is achieved for that point which is “hit” first by the plane wave of absolute slope λ (S=−λ) impinging on the rate-distortion curve. If every admissible operating point lies on the convex hull, then the absolute slope before the optimal operating point is greater than λ, while the absolute slope after the optimal point is less than or equal to λ. This implies that DCT run-level pairs for the convex R-D curve should satisfy the condition of:

$$\frac{{[ {C}_{i}^{k} ]}^{2}}{{N}_{i}^{k}} \{ \begin{matrix}> λ , k \leq {h}_{i} \\ \leq λ , k < {h}_{i}\end{matrix} \qquad ( 2 )$$

where λ is the Lagrangian multiplier or quality factor, Nᵢ^{k} and Cᵢ^{k} denote the k-th DCT code length and level for the i-th DCT blocks, respectively, and hᵢ denotes the optimal breakpoint value for the i-th DCT blocks. Since the values of Cᵢ^{k} and Nᵢ^{k} are known for both the encoder and decoder, a basic idea of RDDP is that instead of encoding and transmitting the optimal breakpoint value hᵢ, only the quality factor λ is encoded and transmitted to the decoder and then the decoder deduces the breakpoint hᵢ from Cᵢ^{k} and Nᵢ^{k}.

It has been found that the RDDP algorithm using Eq. (2) is near optimal in the sense that only one more run, level pair is included into the base layer compared to the optimal one. This run, level pair is the point on the rate-distortion curve at which the slope turns from being greater than λ to being lower than or equal to λ.

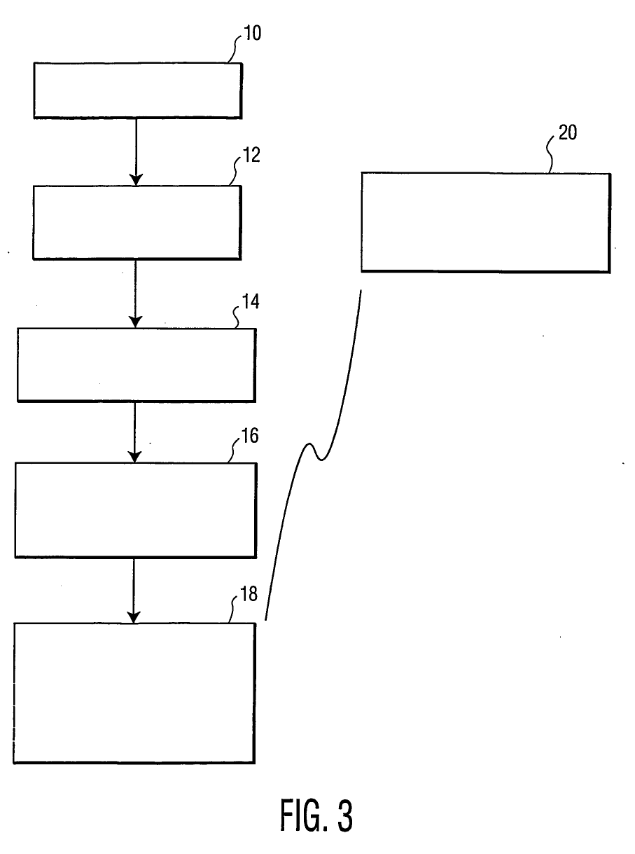

In practice, R-D curves for the DCT blocks are often non-convex. In this case, the partitioning rule given by Eq. (2) is not necessarily valid and the optimality of RDDP is no longer assured. For example, for the non-convex R-D curve shown in FIG. 2, the optimal or priority break point (PBP) value should be k₂ while the RDDP algorithm provides a break point value of k₁, which makes the base layer under-partitioned.

Since the priority break point (PBP) value defines how an encoded bitstream is partitioned, i.e., for decoding purposes, the received bitstreams are decoded based on the priority break point value, it is important to be able to have or determine the same priority break point (PBP) value for both encoding and decoding purposes.

It is an object of the present invention to provide an improved rate-distortion optimized data partitioning technique and algorithm. It is another object of the present invention to provide a rate-distortion optimized data partitioning technique for video using backward adaptation. It is a further object of the present invention to provide a new rate-distortion optimized data partitioning (RDDP) technique which employs an incremental computation algorithm of convex hull and slopes which overcomes drawbacks of other RDDP algorithms.

It is still another object of the present invention to provide a video coding technique which overcomes the limitations of the conventional data partitioning techniques and provides improved base layer optimization.

In order to achieve these objects and others, in accordance with one form of the present invention, a method for partitioning video data into a base layer and at least one enhancement layer includes the steps of receiving video data and separating it into a plurality of frames which are further separated into a plurality of blocks, determining DCT coefficients for the blocks and for each block, quantizing the DCT coefficients, converting the quantized DCT coefficients of the base layer into a set of (run, length) pairs, and determining a partitioning point by analyzing the slope of lines only between adjacent pairs of (run, length) pairs which lie on the convex hull. Once the partitioning point is determined, only those (run, length) pairs before and inclusive of the partitioning point are encoded for transmission in the base layer and those (run, length) pairs after the partitioning point are encoded for transmission in the enhancement layer(s).

In one embodiment, the partitioning point is determined by analyzing the slope of lines only between adjacent pairs of (run, length) pairs which lie on a causally optimal convex hull such that the causally optimal convex hull can be determined synchronously upon encoding the (run, length) pairs and decoding the (run, length) pairs.

More specifically, in one exemplifying method for determining the partitioning point, the slope of lines between all adjacent pair of the (run, length) pairs are determined and a determination is made as to which of the (run, length) pairs lie on the causal convex hull based on the slope of the lines between the adjacent pairs of (run, length) pairs. The partitioning point is then determined based on the slope of the lines between the adjacent pairs of (run, length) pairs which lie on the causal convex hull. For example, the slopes of the lines between the (run, length) pairs which lie on the causal convex hull are compared relative to a quality factor common to all of the blocks in each frame. The quality factor may be placed in a header of the frame. In this manner, the partitioning point for each block, which may vary for each block, is determined based on the slope of the lines between the adjacent pairs of (run, length) pairs which lie on the causal convex hull and on a quality factor common for all blocks in a frame.

Determining which pairs lie on the causal convex hull may entail determining a distortion-length slope between each pair in the set (except for the first and last) and a preceding pair and between that pair and a following pair and determining whether the distortion-length slope between that pair and the following pair is less than the distortion-length slope between that pair and the preceding pair, and if so, considering that pair to lie on the causal convex hull. A causal convex hull set is thus formed from the pairs determined to lie on the causal convex hull and the first pair in the (run, length) set.

In accordance with another form of the present invention, a scalable video system includes a source encoder for encoding video data and outputting encoded data having a base layer and at least one enhancement layer. The encoder determines DCT coefficients for a plurality of blocks of a video frame to form a base layer and at least one enhancement layer, and for each block, quantizes the DCT coefficients, converts the quantized DCT coefficients of the base layer into a set of (run, length) pairs, and determines a partitioning point by analyzing the slope of lines only between adjacent pairs of (run, length) pairs which lie on the convex hull. The encoder then encodes only those (run, length) pairs before and inclusive of the partitioning point into a transmission of the base layer and encodes those (run, length) pairs after the partitioning point into a transmission of the enhancement layer(s). More specifically, the encoder can be designed to determine the partitioning point by determining the slope of lines between all adjacent pairs of the (run, length) pairs, determining which of the (run, length) pairs lie on a causal convex hull based on the slope of the lines between the adjacent pairs of (run, length) pairs, and then determining the partitioning point based on the slope of the lines between the adjacent pairs of (run, length) pairs which lie on the causal convex hull.

The video system can also include a source decoder for decoding video data having the base layer and at least one enhancement layer and outputting decoded data. The decoder decodes the video data based on a partitioning point determined from the causal (run, length) pairs in the base layer and the enhancement layer.

The invention, together with further objects and advantages thereof, may best be understood by reference to the following description taken in conjunction with the accompanying drawings, wherein like reference numerals identify like elements and wherein:

FIG. 1 is an example of a convex rate-distortion (R-D) curve;

FIG. 2 shows a non-convex R-D curve for which the application of another RDDP technique would not provide an optimal breakpoint value but for which the embodiment of the present invention can be applied;

FIG. 3 is a flow chart showing the steps in a method for processing video data in accordance with the invention;

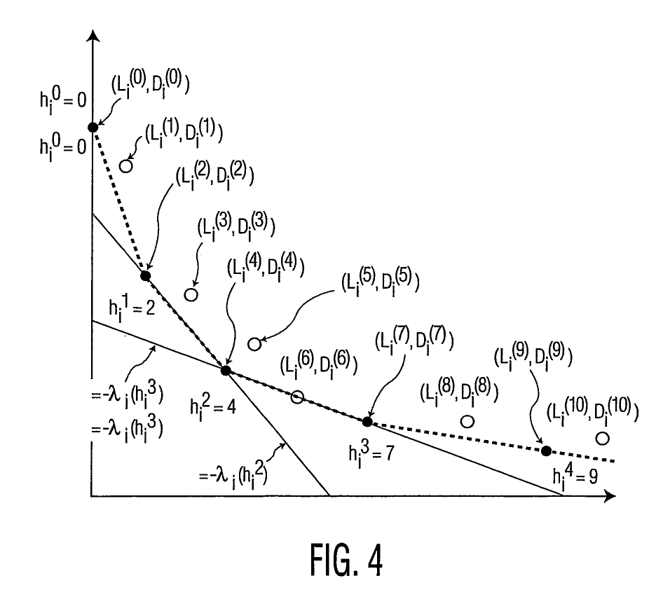

FIG. 4 shows a convex hull formed by truncation points for a DCT block in which the algorithm in accordance with the invention is applied; and

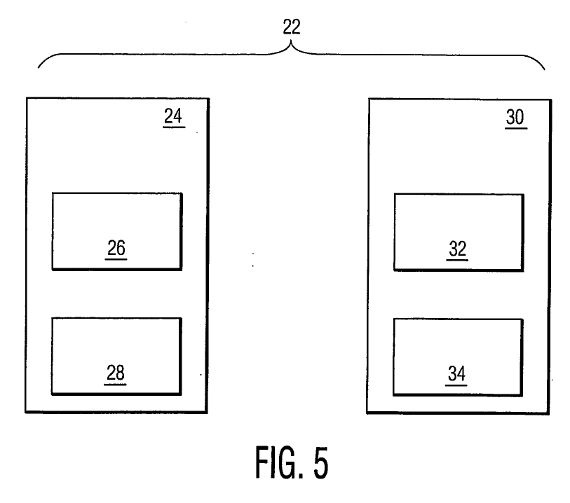

FIG. 5 is a schematic of a video system capable of applying the techniques in accordance with the invention.

The invention is applicable in a scalable video system with layered coding and transport prioritization in which a layered source encoder encodes input video data and a layered source decoder decodes the encoded data. The output of the source encoder includes a base layer and one or more enhancement layers. A plurality of channels carry the output encoded data.

There are different ways of implementing layered coding. For example, in temporal domain layered coding, the base layer contains a bit stream with a lower frame rate and the enhancement layers contain incremental information to obtain an output with higher frame rates. In spatial domain layered coding, the base layer codes the sub-sampled version of the original video sequence and the enhancement layers contain additional information for obtaining higher spatial resolution at the decoder. Generally, a different layer uses a different data stream and has distinctly different tolerances to channel errors. To combat channel errors, layered coding is usually combined with transport prioritization so that the base layer is delivered with a higher degree of error protection. If the base layer is lost, the data contained in the enhancement layers may be useless.

The video quality of the base layer may be flexibly controlled at the DCT block level. The desired base layer can be controlled by adapting the PBP value at the DCT block level by employing parametric RD model to approximate the convex hull of the RD planes for each DCT blocks, thereby finding the optimal partitioning points synchronously at the encoder and decoder.

DCT is used to reduce the spatial correlation between adjacent error pixels, and to compact the energy of the error pixels into a few coefficients. Since many high frequency coefficients are zero after quantization, variable length coding (VLC) is accomplished by a run-length coding method, which orders the coefficients into a one-dimensional array using a so-called zig-zag scan so that the low-frequency coefficients are put in front of the high-frequency coefficients. This way, the quantized coefficients are specified in terms of the non-zero values and the number of the preceding zeros. Different symbols, each corresponding to a pair of zero run-length, and non-zero value, are coded using variable length codewords.

The scalable video system may use entropy coding in which quantized DCT coefficients are rearranged into a one-dimensional array by scanning them in a zig-zag order. This rearrangement puts the DC coefficient at the first location of the array and the remaining AC coefficients are arranged from the low to high frequency, in both the horizontal and vertical directions. The assumption is that the quantized DCT coefficients at higher frequencies would likely be zero, thereby separating the non-zero and zero parts. The rearranged array is coded into a sequence of the run-level pair. The run is defined as the distance between two non-zero coefficients in the array. The level is the non-zero value immediately following a sequence of zeros. This coding method produces a compact representation of the 8×8 DCT coefficients, since a large number of the coefficients have been already quantized to zero value.

The run-level pairs and the information about the macroblock, such as the motion vectors, and prediction types, are further compressed using entropy coding. Both variable-length and fixed-length codes are used for this purpose.

The design of the video system is motivated by the operational rate-distortion (RD) theory. RD theory is useful in coding and compression scenarios, where the available bandwidth is known a priori and where the purpose is to achieve the best reproduction quality that can be achieved within this bandwidth (i.e., adaptive algorithms).

Referring now to FIG. 3, in accordance with the present invention, an incremental computation algorithm is employed for convex hull and slope R-D curves such as shown in FIG. 2. The incremental algorithm computes the convex hull and R-D slope for each DCT block of each video frame using preceding run-length variable length coder (VLC) pairs in a computationally efficient manner. The computation of the convex hull is causal-optimal in the sense that the computed convex hull is the true convex hull for the given causal pairs of (run, length) pairs. Therefore, the same convex hull and R-D slope can be computed synchronously at the encoder and decoder.

Generally, for each DCT block of a video frame, the DCT coefficients are quantized and converted into a set of (run, length) pairs (step 10). Each (run, length) pair is represented by (Lᵢ^{(k)}, Dᵢ^{(k)}) as shown in FIG. 4. The slope of the lines between each adjacent pair of (run, length) pairs is then determined (step 12). For example, the slope between the initial (run, length) pair (designated 0) and the second (run, length) pair (designated 1), the slope between the initial (run, length) pair (designated 0) and the second (run, length) pair (designated 1), etch are determined.

Once the slope between each adjacent pair of (run, length) pairs is determined, a determination is made as to which (run, length) pairs lie on the convex hull (step 14). Encoding and decoding of the block of the video frame is based on the determined slopes of the line.

This technique will be illustrated with reference to FIG. 4 wherein the R-D pairs of the (run, length) of the i-th DCT block are shown and (Lᵢ^{(k)}, Dᵢ^{(k)}) denotes the rate-distortion pairs of the base layer including up to k (run, length) pairs, and hᵢ^{p} denotes the p-th rate-distortion pairs on the convex hull. The convex hull slope (designated S) which equals −λᵢ(hᵢ^{p}) denotes the “distortion-length” slope at hᵢ^{p}.

As shown in FIG. 4, some of the rate-distortion pairs do not lie on the convex hull. Namely, only 5 (run, length) pairs, (Lᵢ^{(k)}, Dᵢ^{(k)}) for k=0, 2, 4, 7 and 9, lie on the convex hull. The solution for the optimization problem, the minimization of the cost function, Eq. (1), will be among those five rate-distortion pairs, i.e., hε{0,2,4,7,9}. Thus, if we have all the access of the rate-distortion pairs, only these rate-distortion pairs will be used to determine the partitioning slope, between the base layer and the enhancement layer. In order to find the feasible points, the convex hull and the resultant distortion-length slopes are computed. An exemplifying fast incremental computation algorithm of the convex hull and distortion-length slope is given as follows:

```
Set λᵢ(0) [symbol] ∞,Hᵢ [symbol] {0} and h^{last} [symbol] 0.
For z=1,2,...,Zi
    { // for each rate-distortion pair
    Set ΔD [symbol] Dᵢ^{(h}^{^{last}}⁾ − Dᵢ^{(z)} and ΔL [symbol] Lᵢ^{(z)} − Lᵢ^{(h}^{^{last}}⁾ ;
    If ΔD > 0
        {While ΔD > λᵢ(h^{last})ΔL
            {Set Hᵢ [symbol] Hᵢ \{h^{last}} //exclude last elements of current
                convex hull set
            Set h^{last} [symbol] max Hᵢ //get last element in new convex hull
                set
            Set ΔD [symbol] Dᵢ^{(h}^{^{last}}⁾ − Dᵢ^{(z)} and ΔL [symbol] Lᵢ^{(z)} − Lᵢ^{(h}^{^{last}}⁾ }
        Set h^{last} [symbol] z
        Set Hᵢ [symbol] Hᵢ∪{h^{last}}
        Set λ(h^{last}) [symbol] ΔD/ΔL } }
```

In the above algorithm, Hᵢ denotes the convex hull set, which is continuously being updated as more rate-distortion pairs are processed. In the data-partitioning problem, ΔD and ΔL can be easily computed as follows:

$$Δ D = {D}_{i}^{( {h}^{last} )} - {D}_{i}^{( z )} = {\sum }_{k = {h}^{last}}^{z} {[ {C}_{i}^{k} ]}^{2}$$

$$Δ L = {L}_{i}^{( {h}^{last} )} - {L}_{i}^{( z )} = {\sum }_{k = {h}^{last}}^{z} {N}_{i}^{k}$$

where Cᵢ^{k}, Nᵢ^{k} denotes the de-quantized DCT coefficient and code length of the k-th DCT (run, length) pairs.

Once the (run, length) pairs on the convex hull are determined, the partitioning point for each block is determined based on the quality factor 8 (which is the same for all blocks in the same frame) and the slope of the lines between the adjacent pairs of (run, length) pairs on the convex hull (step 16).

The algorithm is not causal in the sense that all the rate-distortion pairs should be processed to construct the “true” convex hull and the distortion-length slope. Without side information, the decoder can only decide the partitioning points based on the causal rate-distortion pairs. Therefore, in a preferred embodiment, the above convex hull search algorithm is modified to use only causal rate-distortion or (run, length) pairs. By applying the algorithm described above and Eq. (1), the partitioning point can be obtained from the causal (run, length) pairs and those (run, length) pairs before the partitioning point are encoded into the base layer (regardless of whether they lie on the convex hull or not) while the (run, length) pairs after the partitioning point are encoded into the enhancement layer(s) (step 18) In this manner, the invention provides a new partitioning rule without requiring the transmission of side information based on causally optimal convex hull computation.

At the decoder side, the decoder receives the transmitted base layer and enhancement layer(s) and based on the (run, length) pairs included in the base layer and enhancement layer, it calculates the slope of the lines between each adjacent pair of (run, length) pairs, determines which lie on the causal convex hull and then based on the quality factor 8, determines the partitioning point (step 20). Since the same algorithm to determine the partitioning point is used in both the encoder and decoder, the same partitioning point will be obtained. Although the calculation of the slope between the lines is required at both the encoder and decoder side, the advantage of avoiding the transmission of side information is maintained.

With respect to the partitioning between base and enhancement layer, the proposed algorithm is given in the following manner:

ALGORITHM: ENCODER
Encode quality factor quality factor λ into base layer.
$Set {λ}_{i} ( 0 ) ← ∞ , {H}_{i} ← \{ 0 \} and {h}^{last} ← 0.$
For z=1,2, . . . ,Zi

{ // for each run-length pairs
Encode the z-th (run,length) pairs into base layer.
Compute Cᵢ^{z} and Nᵢ^{z}.
$Set ΔD ← {\sum }_{k = {h}^{last}}^{z} {[ {C}_{i}^{k} ]}^{2} and ΔL ← {\sum }_{k = {h}^{last}}^{z} {N}_{i}^{k}$
If ΔD > 0

{While ΔD > λᵢ(h^{last})ΔL

$\{ Set {H}_{i} ← {H}_{i} ∖ \{ {h}^{last} \} \text{//} exclude last elements of current$

convex hull set

$Set {h}^{last} ← max {H}_{i} // get last element in new convex hull$

set

$Set ΔD ← ΔD + {[ {C}_{i}^{{h}^{last}} ]}^{2} and ΔL ← ΔL + {N}_{i}^{{h}^{last}} \}$

$Set {h}^{last} ← z$
$Set {H}_{i} ← {H}_{i} ⋃ \{ {h}^{last} \}$
$Set λ ( {h}^{last} ) ← ΔD / ΔL$
If λ(h^{last}) < λ break.}}

End
Put the remaining (run, length) pairs into the enhancement layer.

At the decoder side, the merging algorithm is given as follows:

ALGORITHM: DECODER
Decode quality factor quality factor λ from base layer.
$Set {λ}_{i} ( 0 ) ← ∞ , {H}_{i} ← \{ 0 \} and {h}^{last} ← 0.$
For z=1,2, . . . ,Zi

{ // for each run-length pairs
Decode the z-th (run,length) pairs from the base layer.
Compute Cᵢ^{z} and Nᵢ^{z}.
$Set ΔD ← {\sum }_{k = {h}^{last}}^{z} {[ {C}_{i}^{k} ]}^{2} and ΔL ← {\sum }_{k = {h}^{last}}^{z} {N}_{i}^{k}$
If ΔD > 0

{While ΔD > λᵢ(h^{last})ΔL

$\{ Set {H}_{i} ← {H}_{i} ∖ \{ {h}^{last} \} \text{//} exclude last elements of current$

convex hull set

$Set {h}^{last} ← max {H}_{i} // get last element in new convex hull$

set

$Set ΔD ← ΔD + {[ {C}_{i}^{{h}^{last}} ]}^{2} and ΔL ← ΔL + {N}_{i}^{{h}^{last}} \}$

$Set {h}^{last} ← z$
$Set {H}_{i} ← {H}_{i} ⋃ \{ {h}^{last} \}$
$Set λ ( {h}^{last} ) ← ΔD / ΔL$
If λ(h^{last}) < λ break.}}

End
Decode remaining (run, length) pairs from the enhancement layer.

Note that the proposed algorithm is causally optimal in the sense that the resultant convex hull is the optimal convex hull given the causal (run, length) pairs. Hence, the decoder can also reconstruct the identical convex hull and furthermore, the identical partitioning points by comparing the quality factor λ.

FIG. 5 shows a scalable video system 22 capable of applying the algorithms described above. The scalable video system includes a scalable source encoder 24 capable of partitioning data into a base layer and at least one enhancement layer having data representing (run, length) pairs for a plurality of macroblocks in a video frame. The encoder 24 includes a memory 26 which stores computer-executable process steps and a processor 28 which executes the process steps stored in the memory 26 so as to determine a partitioning point. This may be accomplished in the manner described above, for example, by analyzing the slope of lines only between adjacent pairs of (run, length) pairs which lie on a causal convex hull and include in the base layer only the (run, length) pairs before and inclusive of the partitioning point and include in the enhancement layer(s), the (run, length) pairs after the partitioning point. The processor 28 can thus determine the partitioning point by determining the slope of lines between all adjacent pairs of the (run, length) pairs and determining which of the (run, length) pairs lie on the causal convex hull based on the slope of the lines between the adjacent pairs of (run, length) pairs. The partitioning point is then determined based on the slope of the lines between the adjacent pairs of (run, length) pairs which lie on the causal convex hull.

The system 22 also includes a scalable decoder 30 capable of merging data from the base layer and the enhancement layer(s). The decoder 30 includes a memory 32 which stores computer-executable process steps and a processor 34 which executes the process steps stored in the memory 32 so as to receive the base layer and the enhancement layer(s) and determine a partitioning point based on the (run, length) pairs included in the base layer and in the enhancement layer(s) by analyzing only causal (run, length) pairs.

Although illustrative embodiments of the present invention have been described herein with reference to the accompanying drawings, it is to be understood that the invention is not limited to these precise embodiments, and that various other changes and modifications may be effected therein by one of ordinary skill in the art without departing from the scope or spirit of the invention.

1. A method for partitioning video data into a base layer and at least one enhancement layer, comprising the steps of:
separating the video data into a plurality of frames (10);
separating each frame into a plurality of blocks (10);
determining DCT coefficients for the blocks (10);
for each block,
quantizing the DCT coefficients (10),
converting the quantized DCT coefficients into a set of (run, length) pairs at least a portion of which lie on a convex hull (10),
determining a partitioning point by analyzing the slope of lines only between adjacent pairs of (run, length) pairs which lie on the convex hull (12, 14, 16); and
encoding only those (run, length) pairs before and inclusive of the partitioning point into a transmission of a base layer and encoding those (run, length) pairs after the partitioning point into a transmission of at least one enhancement layer (18).

2. The method of claim 1, wherein the step of determining the partitioning point (12, 14, 16) comprises the step of analyzing the slope of lines only between adjacent pairs of (run, length) pairs which lie on a causally optimal convex hull such that the causally optimal convex hull is determinable synchronously upon encoding the (run, length) pairs and decoding the (run, length) pairs.

3. The method of claim 2, wherein the step of determining the partitioning point (12, 14, 16) comprises the steps of:
determining the slope of lines between all adjacent pair of the (run, length) pairs (12);
determining which of the (run, length) pairs lie on the causal convex hull based on the slope of the lines between the adjacent pairs of (run, length) pairs (14); and then
determining the partitioning point based on the slope of the lines between the adjacent pairs of (run, length) pairs which lie on the causal convex hull (16).

4. The method of claim 3, wherein the step of determining the partitioning point (12, 14, 16) based on the slope of the lines between the adjacent pairs of (run, length) pairs which lie on the causal convex hull comprises the step of comparing the slopes of the lines relative to a quality factor common to all of the blocks in each frame.

5. The method of claim 4, further comprising the step of placing the quality factor in a header of the frame.

6. The method of claim 3, wherein the partitioning point is determined based on the slope of the lines between the adjacent pairs of (run, length) pairs which lie on the causal convex hull and on a quality factor common for all blocks in a frame.

7. The method of claim 3, wherein the step of determining which of the (run, length) pairs lie on the causal convex hull (14) comprises the steps of:
for each of the (run, length) pairs except for the first and last (run, length) pairs in the set,
determining a distortion-length slope between that pair and a preceding pair and between that pair and a following pair; and
determining whether the distortion-length slope between that pair and the following pair is less than the distortion-length slope between that pair and the preceding pair, and if so, considering that pair to lie on the causal convex hull.

8. The method of claim 7, further comprising the step of:
forming a causal convex hull set from the (run, length) pairs determined to lie on the causal convex hull and the first pair in the (run, length) set.

9. A scalable video system (20), comprising:
a source encoder (22) for encoding video data and outputting encoded data comprising a base layer and at least one enhancement layer, said encoder being arranged to separate the video data into a plurality of frames;
separate each frame into a plurality of blocks;
provide a header for each frame;
determine DCT coefficients for the blocks;
for each block,
quantize the DCT coefficients,
convert the quantized DCT coefficients into a set of (run, length) pairs,
determine a partitioning point by analyzing the slope of lines only between adjacent pairs of (run, length) pairs which lie on the causal convex hull, and
encode only those (run, length) pairs before and inclusive of the partitioning point into a transmission of the base layer and encoding those (run, length) pairs after the partitioning point into a transmission of the at least one enhancement layer.

10. The system of claim 9, wherein said encoder (22) is arranged to determine the partitioning point by analyzing the slope of lines only between adjacent pairs of (run, length) pairs which lie on a causally optimal convex hull such that the causally optimal convex hull is determinable synchronously upon encoding the (run, length) pairs and decoding the (run, length) pairs.

11. The system of claim 10, wherein said encoder (22) is arranged to determine the partitioning point by determining the slope of lines between all adjacent pairs of the (run, length) pairs, determining which of the (run, length) pairs lie on the causal convex hull based on the slope of the lines between the adjacent pairs of (run, length) pairs, and then determining the partitioning point based on the slope of the lines between the adjacent pairs of (run, length) pairs which lie on the causal convex hull.

12. The system of claim 11, wherein said encoder (22) is arranged to determine the partitioning point based on the slope of the lines between the adjacent pairs of (run, length) pairs which lie on the causal convex hull by comparing the slopes of the lines relative to a quality factor common to all of the blocks in each frame.

13. The system of claim 9, wherein said encoder (22) is arranged to determine the partitioning point based on a common quality factor for all block in a frame.

14. The system of claim 10, wherein said encoder (22) is arranged to determine which pairs lie on the causal convex hull by determining a distortion-length slope between each pair on the causal convex hull and a preceding pair and between that pair and a following pair and determine whether the distortion-length slope between that pair and the following pair is less than the distortion-length slope between that pair and the preceding pair, and if so, considering that pair to lie on the causal convex hull.

15. The system of claim 9, further comprising
a source decoder (28) for decoding video data comprising the base layer and at least one enhancement layer and outputting decoded data, said decoder (28) being arranged to analyze the (run, length) pairs in the base layer and in the at least one enhancement layer to determine the partitioning point for use in decoding the video data.

16. The system of claim 15, wherein said decoder (28) includes a memory (30) which stores computer-executable process steps and a processor (32) which executes the process steps stored in said memory (30) so as to (i) receive the base layer and the at least one enhancement layer, and (ii) determine a partitioning point based on the (run, length) pairs included in the base layer and in the at least one enhancement layer by analyzing only causal (run, length) pairs.

17. The system of claim 9, wherein said encoder (22) includes a memory (24) which stores computer-executable process steps and a processor (26) which executes the process steps stored in said memory (24) so as to determine a partitioning point by analyzing the slope of lines only between adjacent pairs of (run, length) pairs which lie on a causal convex hull and include in the base layer only the (run, length) pairs before and inclusive of the partitioning point and include in the at least one enhancement layer the (run, length) pairs after the partitioning point.

18. A scalable encoder (22) capable of partitioning data into a base layer and at least one enhancement layer which include data representing (run, length) pairs for a plurality of macroblocks in a video frame, the encoder comprising:
a memory (24) which stores computer-executable process steps; and
a processor (26) which executes the process steps stored in said memory (24) so as to determine a partitioning point by analyzing the slope of lines only between adjacent pairs of (run, length) pairs which lie on a causal convex hull and include in the base layer only the (run, length) pairs before and inclusive of the partitioning point and include in the at least one enhancement layer the (run, length) pairs after the partitioning point.

19. The encoder of claim 18, wherein said processor (26) is arranged to determine the partitioning point by (i) determining the slope of lines between all adjacent pairs of the (run, length) pairs, (ii) determining which of the (run, length) pairs lie on the causal convex hull based on the slope of the lines between the adjacent pairs of (run, length) pairs, and then (iii) determining the partitioning point based on the slope of the lines between the adjacent pairs of (run, length) pairs which lie on the causal convex hull.

20. A scalable decoder (28) capable of merging data from a base layer and at least one enhancement layer which include data representing (run, length) pairs for a plurality of macroblocks in a video frame, the decoder (28) comprising:
a memory (30) which stores computer-executable process steps; and
a processor (32) which executes the process steps stored in said memory (30) so as to (i) receive the base layer and the at least one enhancement layer, and (ii) determine a partitioning point based on the (run, length) pairs included in the base layer and in the at least one enhancement layer by analyzing only causal (run, length) pairs.
